(19) United States
(12) Patent Application Publication
(10) Pub. No.: US 2023/0182756 A1
(43) Pub. Date: Jun. 15, 2023

(54) SYSTEMS AND METHODS TO USE PEAK POWER IN A TARGETED MANNER

(71) Applicant: Cummins Inc., Columbus, IN (US)

(72) Inventors: Harsha Ravindra ADEMANE, Indianapolis, IN (US); Kenneth M. FOLLEN, Greenwood, IN (US); John P, KRESSE, III, Martinsville, IN (US)

(21) Appl. No.: 17/911,975

(22) PCT Filed: Mar. 20, 2020
(86) PCT No.: PCT/US2020/023929

§ 371 Date: Sep. 15, 2022

(51) Int. Cl. B60W 50/12; B60W 30/08

(52) U.S. Cl. CPC B60W 50/12; B60W 30/08; B60W 2510/305

(57) ABSTRACT

A system and method of utilizing a power boost feature is disclosed. The power boost feature enables the vehicle to produce a greater amount of power when needed, for example, to provide launch assist or overtake assist in a vehicle. A power boost request processor may receive information from a plurality of information systems of the vehicle, including, for example, vehicle mass, enablement of an accelerator pedal kick down switch, an amount of time passed between power boost system functions as communicated by a timer, operation and/or status of a cooling system, system enablement, transmission enablement, vehicle speed, position of an accelerator pedal, grade of the road as communicated by a road-grade sensor, actual vehicle power, actual available vehicle power, available battery power, look ahead information, powertrain health, route information, existence of emission zones, weather, and advanced driver-assistance systems.

### FIELD OF THE DISCLOSURE

The present disclosure relates to systems and methods of using a power boost feature in vehicles. Specifically, the present disclosure relates to the use of look ahead features to determine whether or not a power boost feature should be utilized.

### BACKGROUND OF THE DISCLOSURE

Power boost features may be used to provide a vehicle with extra power when needed in a variety of scenarios. However, several variables can change how a power boost event affects the vehicle or the vehicle’s route. To optimize a vehicle’s efficiency and health index, all variables should be accounted for. Furthermore, giving a driver or user further information related to the operation of the vehicle and the potential availability of a power boost event may improve vehicle operation.

### SUMMARY OF THE DISCLOSURE

A system and method of utilizing a power boost feature is disclosed. The power boost feature enables the vehicle to produce a greater amount of power when needed, for example, to provide launch assist or overtake assist in a vehicle. A power boost request processor may receive information from a plurality of information systems of the vehicle, including, for example, vehicle mass, enablement of an accelerator pedal kick down switch, an amount of time passed between power boost system functions as communicated by a timer, operation and/or status of a cooling system, system enablement, transmission enablement, vehicle speed, position of an accelerator pedal, grade of the road as communicated by a road-grade sensor, actual vehicle power, actual available vehicle power, available battery power, look ahead information, powertrain health, route information, existence of emission zones, weather, and advanced driver-assistance systems.

In an exemplary embodiment of the present disclosure, a power boost system is disclosed. The power boost system comprises a processor configured to determine the level of available power boost and at least one information system communicatively coupled to the processor to provide information needed by the processor. The level of available power boost is determined by at least one of: a chance of damage or wear to components; a chance of reduced system performance; efficiency for current conditions or need for a power boost event; and a chance of a vehicle safety event. The processor is further configured to apply the determined power boost level to a powertrain of a vehicle.

The information system communicatively coupled to the processor may include a position of an accelerator pedal, a state of an accelerator pedal kick down switch, an enablement switch on a dash of the vehicle, or a touch-screen display of the vehicle. The power boost system may further comprise a user interface comprising a digital output, a datalink status message, or a combination of the datalink status message and the digital output to communicate and display information by the processor, including the level of available power boost. The power boost system may further comprise an event log communicatively coupled to the processor.

In another exemplary embodiment of the present disclosure, a method of using a power boost system is disclosed. The method comprises: requesting a power boost event via an information system communicatively coupled to a processor; determining the level of available power boost via the processor; and applying the determined power boost level to a powertrain of a vehicle. The level of available power boost is determined by at least one of: a chance of damage or wear to components; a chance of reduced system performance; efficiency for current conditions or need for the power boost event; and a chance of a vehicle safety event.

The information system communicatively coupled to the processor for request of power boost function may include a position of an accelerator pedal, a state of an accelerator pedal kick down switch, an enablement switch on a dash of the vehicle, or a touch-screen display of the vehicle. The power boost system may include a user interface comprising a digital output, a datalink status message, or a combination of the digital output and the datalink status message, to communicate and display information by the processor, including level of available power boost. The power boost system may include an event log communicatively coupled to the processor. The level of available boost may have a range between 0 and 100% of a reference value. The level of available boost may have a value of either 0 or 100% of a reference value.

The information system of the method may comprise at least one of the following when considering the chance of damage or wear to components: a battery health index; a battery temperature; an electric machine temperature; a power electronics temperature; a battery state of charge; and a torque capacity of a driveline or a transmission. The processor may limit the level of the power boost event when at least one of: the battery health index is below a calibratable threshold; the powertrain health index is below a calibratable threshold; a battery temperature is above or equal to a first predetermined battery thermal threshold; the battery temperature is below or equal to a second predetermined battery thermal threshold; an electric machine temperature is above or equal to a first predetermined electric machine thermal threshold; the electric machine temperature is below or equal to a second predetermined electric machine thermal threshold; a power electronics temperature is above or equal to a first predetermined power electronics thermal threshold; the power electronics temperature is below or equal to a second predetermined power electronics thermal threshold; a state of charge of a battery is equal to or below a predetermined minimum state of charge threshold; a predicted battery health index is below a first calibratable threshold; a predicted powertrain health index is below a second calibratable threshold; a predicted battery temperature is above or equal to the first predetermined battery thermal threshold; the predicted battery temperature is below or equal to the second predetermined battery thermal threshold; a predicted electric machine temperature is above or equal to the first predetermined electric machine thermal threshold; the predicted electric machine temperature is below or equal to the second predetermined electric machine thermal threshold; a predicted power electronics temperature is above or equal to the first predetermined power electronics thermal threshold; the predicted power electronics temperature is below or equal to the second predetermined power electronics thermal threshold; a predicted state of charge of the battery is equal to or below the predetermined minimum state of charge threshold; a torque capacity of a driveline or a transmission is predicted to be exceeded; and any combination of the above events.

The information system may include at least one of the following when considering the chance of reduced system performance: the battery state of charge; available battery power; and available electric machine power. The processor may limit the level of the power boost event when at least one of: the available electric machine power is below or equal to a predetermined electric machine power threshold; the available battery power is below or equal to a predetermined battery power threshold; a predicted available electric machine power is below or equal to the predetermined electric machine power threshold; a predicted available battery power is below or equal to the predetermined battery power threshold; and any combination of the above events.

The information system may include at least one of the following when considering efficiency for current conditions or need for the power boost event: a look ahead information system; a mass of a battery electric vehicle; a speed of a battery electric vehicle; a position of an accelerator pedal; a road-grade sensor; and a state of an accelerator pedal kick down switch. The processor may limit the level of the power boost event when at least one of: the speed of the battery electric vehicle is not in compliance with a predetermined maximum speed threshold; an acceleration rate of the vehicle is high in comparison with the position of the accelerator pedal; a predicted speed of the battery electric vehicle is not in compliance with the predetermined maximum speed threshold; a predicted acceleration rate of the battery electric vehicle is high in comparison with the position of the accelerator pedal; the processor otherwise determines enablement of the power boost event is inefficient; or any combination of the above events.

The information system may include at least one of the following when considering the chance of a vehicle safety event: a look ahead information system; an advanced driver-assistance system; and a weather condition. The processor may limit the level of the power boost event when at least one of: the weather condition includes at least one of an ice event, a snow event, and a rain event, wherein the weather condition causes slippery road conditions; the advanced driver-assistance system indicates that a current battery electric vehicle is in traffic or another vehicle is otherwise closely located to the current battery electric vehicle; a predicted weather condition includes at least one of an ice event, a snow event, and a rain event, wherein the predicted weather condition is predicted to cause slippery road conditions; traffic is predicted on a route of the current battery electric vehicle; or any combination of the above events.

In yet another exemplary embodiment of the present disclosure, a method of using a power boost system is disclosed. The method comprises: requesting a power boost event via an information system communicatively coupled to a processor; determining the level of available power boost via the processor; and applying the determined power boost level to a power train system. The level of available power boost is determined by at least one of: a chance of damage or wear to components; a chance of reduced system performance, efficiency for current conditions or need for a power boost event; a chance of a vehicle safety event; and a chance for increased emissions.

The information system may comprise at least one of the following when considering the chance of damage or wear to components: a battery health index; a powertrain health index; a battery temperature; an electric machine temperature; a power electronics temperature; a battery state of charge; and a torque capacity of a driveline or a transmission. The processor may limit the level of the power boost event when at least one of: the battery health index is below a first calibratable threshold; the powertrain health index is below a second calibratable threshold; the battery temperature is above or equal to a first predetermined battery thermal threshold; the battery temperature is below or equal to a second predetermined battery thermal threshold; the electric machine temperature is above or equal to a first predetermined electric machine thermal threshold; the electric machine temperature is below or equal to a second predetermined electric machine thermal threshold; the power electronics temperature is above or equal to a first predetermined power electronics thermal threshold; the power electronics temperature is below or equal to a second predetermined power electronics thermal threshold; the battery state of charge is equal to or below a predetermined minimum state of charge threshold; a predicted battery health index is below the first calibratable threshold; a predicted powertrain health index is below the second calibratable threshold; a predicted battery temperature is above or equal to the first predetermined battery thermal threshold; the predicted battery temperature is below or equal to the second predetermined battery thermal threshold; a predicted electric machine temperature is above or equal to the first predetermined electric machine thermal threshold; the predicted electric machine temperature is below or equal to the second predetermined electric machine thermal threshold; a predicted power electronics temperature is above or equal to the first predetermined power electronics thermal threshold; the predicted power electronics temperature is below or equal to the second predetermined power electronics thermal threshold; a predicted battery state of charge is equal to or below the predetermined minimum state of charge threshold; the torque capacity of the driveline or the transmission is predicted to be exceeded; and any combination of the above events.

The information system may include one of the following when considering the chance of reduced system performance: the battery state of charge; an available battery power; and an available electric machine power. The processor may limit the level of the power boost event when at least one of: the available electric machine power is below or equal to a predetermined electric machine power threshold; the available battery power is below or equal to a predetermined battery power threshold; a predicted available electric machine power is below or equal to the predetermined electric machine power threshold; a predicted available battery power is below or equal to the predetermined battery power threshold; and any combination of the above events.

The information system may include at least one of the following when considering efficiency for current conditions or need for the power boost event: a look ahead information system; a mass of a battery electric vehicle; a speed of the battery electric vehicle; a position of an accelerator pedal; a road-grade sensor; and an accelerator pedal kick down switch. The processor may limit the level of the power boost event when at least one of: the speed of the battery electric vehicle is not in compliance with a predetermined maximum speed threshold; an acceleration rate of the battery electric vehicle is high in comparison with the position of the accelerator pedal; a predicted speed of the battery electric vehicle is not in compliance with the predetermined maximum speed threshold; a predicted acceleration rate of the battery electric vehicle is high in comparison with the position of the accelerator pedal; the processor otherwise determines enablement of the power boost feature is inefficient; or any combination of the above events.

The information system may include at least one of the following when considering the chance of a vehicle safety event: a look ahead information system; an advanced driver-assistance system; and a weather condition. The processor may limit the level of the power boost event when at least one of: the weather condition includes at least one of an ice event, a snow event, and a rain event, wherein the weather condition causes slippery road conditions; the advanced driver-assistance system indicates that a current battery electric vehicle is in traffic or another vehicle is otherwise closely located to the current battery electric vehicle; a predicted weather condition includes at least one of an ice event, a snow event, or a rain event, wherein the predicted weather condition is predicted to cause slippery road conditions; traffic is predicted on a route of the battery electric vehicle; or any combination of the above events.

The processor may source a portion of needed electrical energy from a range extender of a range extended vehicle to allow for an increase in the available level of power boost considering at least one of: the battery health index remains above a calibratable threshold; the powertrain health index remains above a calibratable threshold; the battery temperature remains below a predetermined battery thermal threshold; the electric machine temperature remains below a predetermined electric machine thermal threshold; power electronics temperature remains below a predetermined power electronics thermal threshold; the battery state of charge remains above a predetermined minimum state of charge threshold; a predicted battery health index remains above the calibratable threshold; a predicted battery temperature remains below a predetermined battery thermal threshold; a predicted electric machine temperature remains below a predetermined electric machine thermal threshold; a predicted power electronics temperature remains below a predetermined power electronics thermal threshold; a predicted battery state of charge remains above a predetermined minimum state of charge threshold; or any combination of the above events. The processor may source a portion of needed electrical energy from the range extender of the range extended vehicle to ensure that: an available battery power remains above or equal to a predetermined minimum battery power threshold; a predicted available battery power remains above or equal to a predetermined minimum battery power threshold; or any combination of the above events.

The information system may include at least one of the following when considering the chance for increased emissions: an aftertreatment system status; an existence of a zero emission zone or a low emission zone; and a look ahead information system. The processor may limit the level of the power boost event so that enablement of the power boost feature does not require the processor to source a portion of an amount of needed electrical energy from a range extender of a range extended electric vehicle when the aftertreatment system status indicates a low emissions conversion efficiency. The processor may limit the level of the power boost event so that enablement of the power boost feature does not require the processor to source a portion of an amount of needed electrical energy from a range extender of a range extended electric vehicle when use of the range extender will cause the range extended electrical vehicle to output emissions equal to or above a predetermined emissions output threshold. The range extended electrical vehicle may be in a zero emissions zone, a low emissions zone, is predicted to be in a zero emissions zone, or is predicted to be in a low emissions zone.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 is a flowchart illustrating a power boost system, including the direction of the flow of information for determining the availability of a power boost event;

FIG. 2 is a flowchart illustrating an example of the power boost system of FIG. 1;

FIG. 3 is a flowchart illustrating an example of a power boost system for a battery electric vehicle having a multi-speed transmission;

FIG. 4 is a flowchart illustrating an example of a power boost system for a battery electric vehicle having a multi-speed transmission and a look-ahead feature;

FIG. 5 is a flowchart illustrating an example of a power boost system for a range extended electric vehicle having a multi-speed transmission and an optional look-ahead feature;

FIG. 6 is a graphical view of a comparison of power of a battery electric vehicle at a given range of speed without a power boost feature and power of another battery electric vehicle at the same given range of speed with the power boost feature; and

FIG. 7 is a graphical view of a comparison of the torque of a battery electric vehicle at a given range of speed without a power boost feature and the torque of another battery electric vehicle at the same given range of speed with the power boost feature.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The use of power boost in vehicles helps maximize performance but may result in negative side effects during usage of the power boost feature. For example, an operator may desire utilization of a power boost feature for launch assist at low vehicle speeds when the vehicle has a high gross vehicle mass or for over-taking assist at high vehicle speeds during off-cruise operation. Other situations in which an operator may desire the utilization of a power boost feature can be imagined. The power boost feature of the present disclosure can be applied to several different powertrain architectures, including hybrid or all-electric vehicles with a series battery configuration, a parallel battery configuration, or other battery electric vehicles. Hybrid or all-electric vehicles may include battery electric vehicles (BEVs) or range extended electric vehicles (REEVs), also known as series hybrids. It is within the scope of the present disclosure that the systems and methods described herein can be applied to other vehicle types, such as conventional gasoline, diesel, or natural gas-powered vehicles, fuel cell hybrids, and other powertrain configurations.

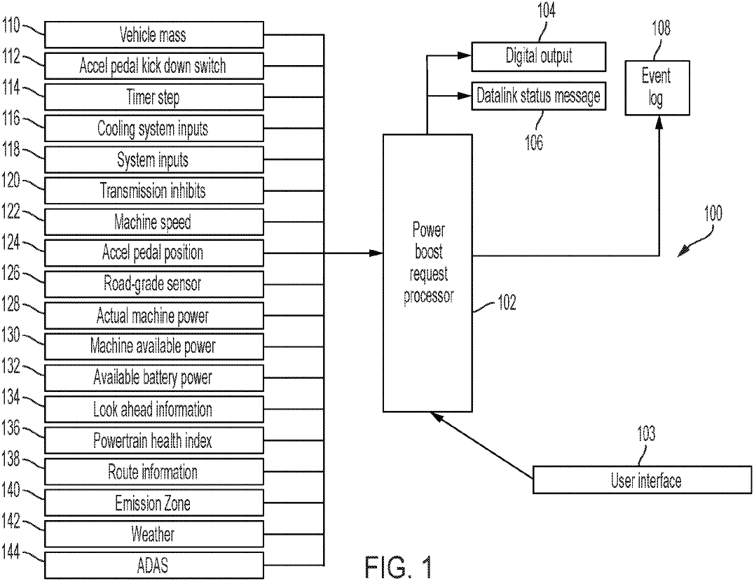

Referring to FIG. 1, a power boost system 100 configured for enabling a power boost event is disclosed for use with a vehicle. The power boost system 100 includes a power boost request processor 102 communicatively coupled to a driver interface 103. The power boost system further includes a digital output 104 and a datalink status message 106, which may be combined with the driver interface 103. The processor 102 is further communicatively coupled to an event log 108 and receives information from at least one information system of the vehicle. For example, the processor 102 may receive information related to vehicle mass 110, enablement of an accelerator pedal kick down switch 112, an amount of time passed between power boost system functions as communicated by a timer 114, operation and/or status of a cooling system 116, system enablement 118, transmission enablement 120, vehicle speed 122, position of an accelerator pedal 124, grade of the road as communicated by a road-grade sensor 126, actual vehicle power 128, actual available vehicle power 130, available battery power 132, look ahead information 134, battery or powertrain health 136, route information 138, existence of emission zones 140, weather 142, and advanced driver-assistance systems 144. After receiving the relevant information from various sources, the processor 102 may determine at any given point whether or not a power boost event should be enabled, as discussed further herein. For example, a user may request a power boost event from the processor 102 using the driver interface 103 and the processor 102 may allow or refuse the request according to the information received from the various information systems of the vehicle as discussed further herein. The processor 102 may further allow the request at a portion of the power boost feature. For example, the processor 102 may allow the power boost event at any value between and including 0% to 100% of the power boost feature, wherein the range of the power boost feature may be at any value between and including 0% to 100%.

Vehicle mass 110 may be considered by the power boost request processor 102 in determining whether or not the power boost system should be enabled. Because mass is often required for physical movement calculations, information related to the vehicle mass 110 facilitates the processor 102 function by allowing for calculations related to force, work, acceleration, and power. Such calculations can be used to foresee the effect utilization of the power boost feature may have on the vehicle with or without consideration of other vehicle information discussed herein.

An accelerator pedal kick down switch 112 allows for the automatic downshift in an automatic transmission of a vehicle that provides the vehicle with higher power at a lower gear due to the higher rotations per minute (rpm) of the engine. Often the switch 112 is used in conjunction with the accelerator pedal 124 of the vehicle. For example, if the accelerator pedal 124 is pushed by the user past a certain predetermined point, the switch 112 is enabled and the transmission downshifts. In another embodiment, the kick down switch 112 may be enabled by a processor that compares the current speed of the vehicle with the position of the accelerator pedal 124. If the vehicle is not accelerating as much as it should in relation to the position of the accelerator pedal 124, the processor may send a signal to the transmission to downshift. Such an event may occur, for example, while traveling uphill, carrying a heavy load, or pulling a heavy load. Information related to the accelerator pedal kick down switch 112 may be important to the power boost request processor 102, as the kick down mechanism also affects engine power, as well as engine rpm and transmission operation.

In BEVs, or in vehicles not including an engine, the accelerator pedal kick down switch 112 may be implemented to be used as a driver interface to indicate to the vehicle that the driver needs additional power at the time the switch 112 is activated. Additionally, the accelerator pedal kick down switch 112 may be implemented in electric vehicles having multi-speed transmissions, wherein the multi-speed transmission is used to provide additional torque multiplication, especially in commercial vehicles. This use of the accelerator pedal kick down switch 112 may also be implemented in vehicles having engines. In other words, the accelerator pedal kick down switch 112 may be used as an indicator of need for additional power in any vehicle whether or not such indication is accompanied by a downshift of the transmission.

A user may require a predetermined amount of time to pass before subsequent uses of the power boost system 100. Because utilization of the power boost system 100 may affect energy efficiency, for example, it may be desired to allow utilization of the power boost system 100 intermittently rather than on demand, even if all of the remaining information systems are in a favorable position for enablement of a subsequent power boost event. As such, a timer 114 may be utilized to monitor the amount of time that passes between power boost events. In one embodiment, the timer 114 may be programmed with a predetermined time threshold during manufacture or after manufacture through the driver interface 103, for example. If a request for a power boost event is communicated to the power boost request processor 102, the processor 102 accesses information from the timer 114 to determine whether the predetermined time threshold has been met, i.e., if the timer 114 has reset after passing the predetermined time threshold or if the timer 114 registers a time beyond the predetermined time threshold. If the timer 114 is near expiration, a signal may be sent to the user through the driver interface 103. In some embodiments, the timer 114 may be based on a function of temperature of the coolant within the cooling system 116 rather than a frame of time. The timer 114 communicates such information to the power boost request processor 102 to be evaluated, either with or without consideration of other vehicle information discussed herein.

The cooling system 116 of the vehicle serves to keep an engine at a generally consistent target temperature. For example, the cooling system 116 may remove excess heat from the engine, maintain the engine at the most efficient operating temperature, and allow the engine to reach the proper target operating temperature as quickly as possible. If the engine undergoes an internal combustion process, the combustion releases heat, which is then transferred into coolant circulated by the cooling system 116 via a water pump. A cooling fan transfers the heat into air so that the coolant can continue to circulate around the engine to continue pulling heat from the engine. A thermostat serves to monitor the temperature of the engine and control the flow to the cooling fan in order to stabilize, increase, or decrease the temperature of the engine. If the engine is running at a higher rpm, the amount of heat released in a shorter amount of time increases. Such considerations may be communicated to the power boost request processor 102, as the cooling system operation affects efficient and productive operation of the engine. For example, a predetermined thermal threshold may dictate the availability of a power boost event. If the coolant is below the threshold, the power boost request processor 102 may allow a power boost event. If the coolant is above or equal to the threshold, the power boost request processor 102 may disallow a power boost event.

In BEVs, or in vehicles not including an engine, the cooling system 116 may be implemented to cool power electronics, electric machines, and/or batteries of the vehicle. For example, as electric vehicles operate, the power electronics, electric machines, and batteries may generate heat while powering the vehicle. As described with the engine above, the cooling system 116 in such a vehicle may remove excess heat to maintain the vehicle and its components at the most efficient operating temperature. These considerations may be communicated to the power boost request processor 102, as the cooling system operation affects efficient and productive operation of the vehicle and its power components. For example, as described above, a predetermined thermal threshold may dictate the availability of a power boost event. If any of the components are too hot or too cold, then the power boost function may be inhibited or limited as necessary. This application of the cooling system 116 may also be implemented in vehicles having engines. In other words, the cooling system 116 may be implemented in a vehicle to cool the engine, an assortment of electronics, or a combination of the engine and an assortment of electronics.

The power boost system 100 may include system inhibition or enablement 118 and transmission inhibition or enablement 120. For example, the user may select to disallow the power boost system 100 from being enabled upon request. If the system inhibition or enablement feature 118 is disabled, the power boost request processor 102 will automatically inhibit any power boost event, despite a request from a driver. This system inhibition or enablement feature 118 allows further control over the power boost system 100 by completely disabling the system 100 regardless of user request. Similarly, the user may select to disallow certain gear changes of the transmission system using a transmission inhibition or enablement feature 120. For example, in relation to the accelerator pedal kick down switch 112 discussed above, the user may use the transmission inhibition or enablement feature 120 to prevent a kick down of the transmission to a lower gear in an attempt to prevent the powertrain from reaching a higher rpm rate at certain speeds or in certain situations discussed above. The transmission inhibition or enablement feature 120 may also be used to prevent the vehicle from shifting to a neutral mode automatically during, for example, downhill events as discussed further in pending Chinese Application Serial No. CN201911357824.3 to Huang, titled “METHOD OF HYBRID SYSTEM CONTROL,” and filed on Dec. 25, 2019, the entirety of which is hereby incorporated by reference.

Vehicle speed 122 may also be considered by the power boost request processor 102 in determining whether a power boost feature should be utilized upon request. Like mass, velocity is often required for physical movement calculations, including determining a final velocity after an acceleration event, distance traveled during an acceleration event, acceleration, force, work, and power. Such calculations can be used to foresee the effect utilization of the power boost feature may have on the vehicle with or without consideration of other vehicle information discussed herein, including determining if a final vehicle speed is in compliance with a predetermined maximum speed threshold, such as a speed limit imposed by regulation or other desired maximum speed of the vehicle.

The position of the accelerator pedal 124 of the vehicle provides information to the power boost request processor 102 that may facilitate a determination of whether the power boost feature should be enabled upon request. For example, as discussed above in relation to the accelerator pedal kick down switch 112, the position of the accelerator pedal 124 may determine whether the pedal kick down switch 112 is enabled or will potentially be enabled. The position of the accelerator pedal 124 may also provide information to the power boost request processor 102 related to potential acceleration rate of the vehicle, and the power boost request processor 102 may be able to determine if the vehicle is accelerating at the proper rate according to the position of the accelerator pedal 124. If the vehicle’s acceleration rate is low in correspondence with the position of the accelerator pedal 124, the power boost request processor 102 may determine that the vehicle requires more power in a given situation. If the vehicle’s acceleration rate is high in correspondence with the position of the accelerator pedal 124, the power boost request processor 102 may determine that the vehicle does not require more power in a given situation. As with the other information systems discussed herein, the information communicated to the power boost request processor 102 related to the position of the accelerator pedal 124 may be considered with other information systems discussed further herein.

The road-grade sensor 126 provides information relating to the slope of the road on which the vehicle is traveling. During an uphill or downhill event, information related to the grade or slope of the road is an important component in acceleration calculations and other calculations requiring an accurate acceleration calculation due to the effects of gravity. For a vehicle in an uphill event, the gravitational pull works against the forward acceleration of the vehicle, causing the vehicle to slow in relation to the vehicle’s presumed speed according to the position of the accelerator pedal 124, for example. For a vehicle in a downhill event, the gravitational pull results in further acceleration of the vehicle in a forward direction. The road-grade sensor 126 provides information related to the route road-grade to the power boost request processor 102 to facilitate determinations that may be affected by the route road-grade.

The power boost request processor 102 may also consider the actual vehicle power 128 and/or the actual available vehicle power 130. The actual vehicle power 128 includes the power of the vehicle that is being utilized at any given time. The actual available vehicle power 130 is the amount of power available to the vehicle without any further manipulation, i.e. the utilization of the power boost feature. Such information may be used by the power boost request processor 102 to determine whether more power is needed to be provided to the vehicle.

Available battery power 132 may also be provided to the power boost request processor 102 to determine enablement of the power boost feature upon request. For example, the user may input a predetermined state of charge threshold for utilization of the power boost. If the available battery power 132 is below the state of charge threshold, the power boost request processor 102 fails to enable the power boost feature. As discussed further herein, zero emission zones or low emission zones 140 may be identified using look ahead information 134 or route information 138 and may be communicated to the power boost request processor 102 in part to determine whether the power boost feature should be enabled according to the available battery power 132 of the vehicle. For example, if the vehicle is identified as being located in a zero emission zone or a low emission zone 140 and the available battery power 132 is below the predetermined threshold, the power boost request processor 102 will not allow the power boost feature to enable upon request. In another example, if the vehicle is identified as entering a zero emission zone or a low emission zone 140 ahead on the vehicle route and the available battery power 132 is below the predetermined threshold, the power boost request processor 102 will not allow the power boost feature to enable upon request.

If a powertrain or battery health index 136 is below a certain threshold, the power boost system 100 may be disabled. For example, a predetermined health index threshold may be selected by the user. If the powertrain health index 136 is below the predetermined health index threshold, i.e., below a calibratable threshold, the power boost request processor 102 may disallow the utilization of the power boost feature upon request. In a hybrid or otherwise battery-operated vehicle, if the battery health index 136 is below a calibratable threshold, the power boost feature may also be disabled. However, if no diagnostic faults are active in an inverter or within the electric system of the vehicle, the power boost feature may be enabled in consideration with the other information systems discussed herein.

The use of a global positioning system (GPS) is common during operation of a vehicle for both short and long-distance driving. In many vehicles, GPS is integrated into a vehicle operating system. GPS can assist with the prediction of upcoming road conditions based on a route input by an operator. For example, an operator may input a beginning location and an ending location and allow the GPS to autofill a route best suited to the user’s needs. For example, a user may choose between a quickest route, a shortest route, a route comprised of main highways, a route without main highways, a route including toll roads, a route excluding toll roads, etc. In some embodiments, the GPS may detect the vehicle’s location without manual input by the operator. A driver and/or vehicle may otherwise utilize the GPS without a predetermined route to assist with the prediction of upcoming road conditions alone. Road conditions may include, but are not limited to, uphill events, downhill events, curving events, turning events, traffic events (including accidents, stalled vehicles, emergency vehicles, etc.), and the existence of heavy or light traffic. Such operation may comprise predictive road mapping. Predictive road mapping may be utilized by vehicle systems to optimize efficiency of the operation of the vehicle. Further use of predictive road mapping is described in pending Chinese Application Serial No. CN201911357824.3 to Huang, titled “METHOD OF HYBRID SYSTEM CONTROL,” and filed on Dec. 25, 2019, the entirety of which is hereby incorporated by reference.

Also, many commercial vehicles drive cycles that often repeat due to traversing the same route or loop, sometimes several in a day. Such commercial vehicles may include transit vehicles and delivery vehicles. For example, a transit bus can have a fixed drive cycle that includes the exact route, or exact loop that is repeated to form a route, and stop times set by a timetable published by a responsible transit authority. It is therefore possible to define a myriad of route characteristics or statistics of a drive cycle by associating these route characteristics with a known route identification reference, such as a particular route number. The route identification reference can be used to reference information such as distance for a single loop of the route, number of loops of the route per day or other unit of time, a number of opportunities for battery boost charging per loop, a number of scheduled stops per loop, a distance to and between stops, a nominal total energy a vehicle may require to complete a single loop, elevation range, route surface grade, a route surface type, a maximum speed limit, a minimum speed limit, a maximum route trip time, a traffic condition, and other statistics.

For a hybrid vehicle system, many of these route characteristics can be provided to and stored in a hybrid controller. With relatively minimal computer memory burden, route characteristics statistics such as these can be preprogrammed into the hybrid controller such that all that is needed to adjust decisions identified and discussed further herein is the entry of the current route identification reference, either through an operator interface or via a controller, for example. Further information on the storage of route characteristics and route identification may be found in U.S. Pat. Application Publication No. 2018/0134275A1 to Books et al., titled “HYBRID VEHICLE DRIVE CYCLE OPTIMIZATION BASED ON ROUTE IDENTIFICATION” and filed on Nov. 15, 2017, the disclosure of which is herein incorporated by reference in its entirety.

As mentioned above, route information 138 may be utilized by the power boost request processor 102 to identify road conditions such as uphill events, downhill events, curving events, and turning events. Route information 138 may further be utilized by the power boost processor 102 to identify zero emission or low emission zones 140, speed limits, truck routes, and other route information 138. Look ahead information 134 may also be utilized by the power boost request processor 102 to identify events including traffic conditions, changes in traffic speed, existence of zero emission or low emission zones 140, and weather conditions 142. Such information may be used by the power boost request processor 102 alone or in combination with any other information system discussed further herein to determine if a power boost event should or should not be enabled.

Weather conditions 142 may otherwise be communicated to the processor 102 using sensors or another system separate from look ahead information 134. For example, in vehicles not including look ahead information 134, weather conditions 142 may still be identified and communicated to the processor 142 in other ways, including temperature sensors, precipitation sensors, and other sensors that may be imagined to capture and communicate weather characteristics.

Look ahead information 134 may be utilized for simulation models in addition to the route events discussed above in connection with the route information 138. For example, the look ahead information 134 may involve simulation models of the vehicle in a variety of situations, including using route information 138 to conduct a simulation model to determine the effects of a power boost event. The look ahead information 134 may involve simulation models of the vehicle without route information 138 to determine the effect of a power boost event on the other systems of the vehicle, including the battery configuration state of charge, the health index of the powertrain, the temperature of the engine or electronics of a vehicle, or other changes that would occur with the utilization of the power boost feature.

Vehicles may be equipped with advanced driver-assistance systems 144, which assist drivers while driving or during parking events, and are utilized to increase road and car safety. Advanced driver-assistance systems 144 may include adaptive cruise control, glare-free high beams, adaptive light controls, anti-lock braking systems, automatic parking, automotive head-up displays, automotive navigation systems (including systems providing real-time traffic information), automotive night vision, backup cameras, blind spot monitors, collision avoidance systems, crosswind stabilization, cruise controls, driver drowsiness detection systems, driver monitoring systems, warning sounds, electronic stability controls, emergency driver assistants, forward collision warnings, intersection assistants, hill descent controls, hill-start assist, intelligent speed adaptations, lane centering, lane departure warning systems, lane change assistance, parking sensors, surround view systems, tire pressure monitoring, traction control systems, traffic sign recognition, turning assistant, vehicular communication systems, and wrong-way driving warnings, among others. Advanced driver-assistance systems 144 may communicate a variety of information to the power boost request processor 102 that can facilitate a determination related to whether a power boost event should be enabled.

Still referring to FIG. 1, a user/driver may request the enablement of a power boost event from the power boost request processor 102 using the driver interface 103. The user may execute the request by an enablement switch on a dash on the vehicle, a selection on a touch-screen display section of the vehicle, or the request may be executed upon enablement of the accelerator pedal kick down switch 112, among other options. The power boost request processor 102 may further comprise a controller 101 in communication with the driver interface 103 that produces the digital output indicator 104 and/or the datalink status message 106 to communicate the status of the vehicle and the potential availability of the power boost feature to the user. The digital output indicator 104 and/or the datalink status message 106 may further offer a power boost usage suggestion.

When the power boost request processor 102 receives the request and determines, in view of the information received from one or more of the information systems described above, whether to enable the power boost feature. The user may use the power boost feature for a predetermined amount of time as communicated by the timer 114. For example, at low vehicle speeds, the vehicle may utilize the power boost feature for launch assist, especially where the vehicle has a high gross vehicle weight rating. At high vehicle speeds, the vehicle may utilize the power boost feature for over-taking assist in an off-cruise operation. The controller 101 or the power boost request processor 102 is additionally in communication with the event log 108 so that when a power boost event is executed, a log of the event is created and stored within the event log 108 and the timer 114 is reset. As discussed above, the timer 114 is programmed with a predetermined amount of time to pass between power boost events to prevent powertrain health index deterioration.

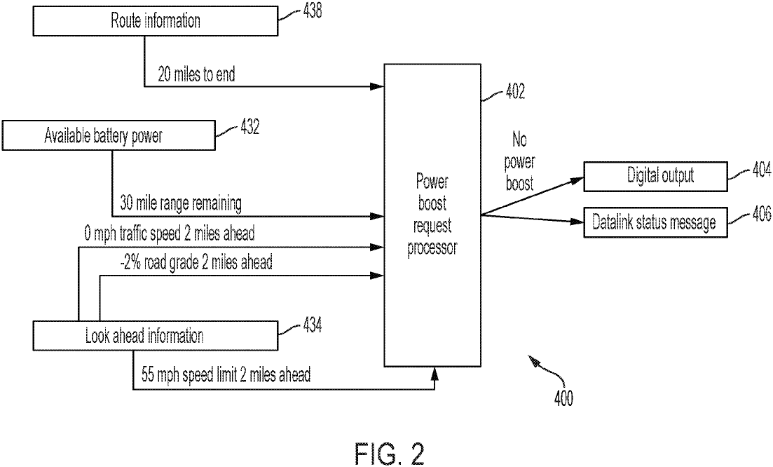

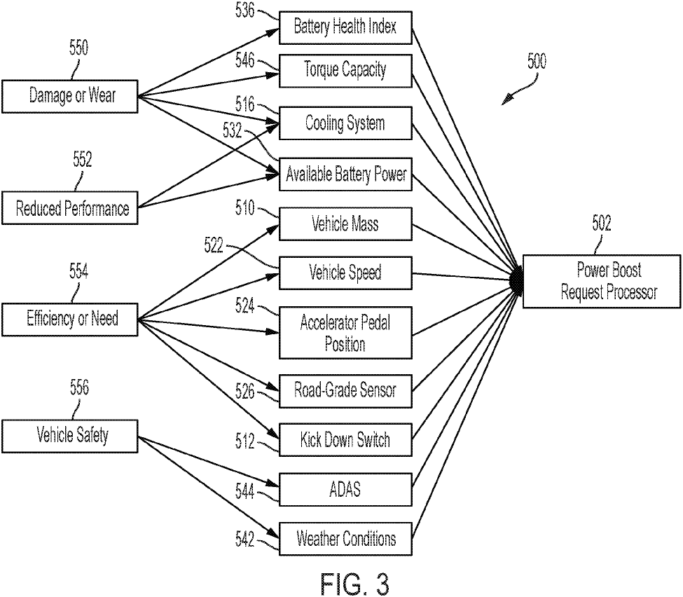

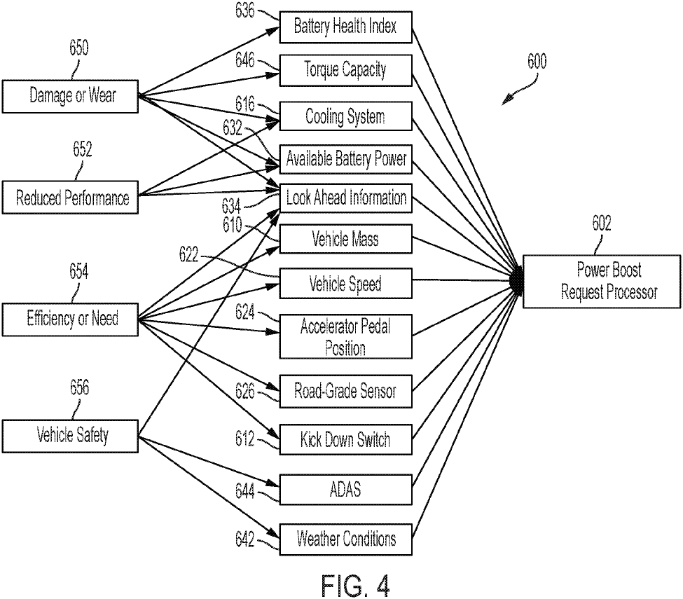

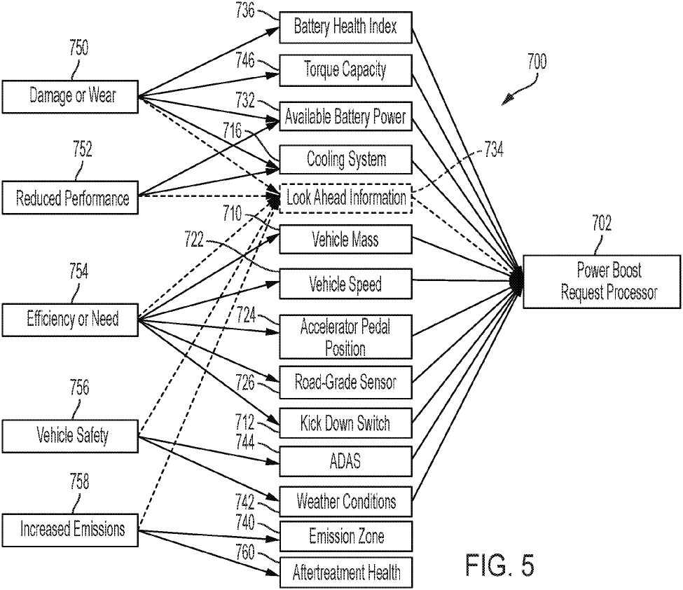

In reference to FIGS. 2-5, like elements are identified by changing the leading “1” to a leading “4” in FIG. 2, a leading “5” in FIG. 3, a leading “6” in FIG. 4, and a leading “7” in FIG. 5.

Referring to FIG. 2, an example of a power boost event request is shown. In example 400, the power boost request processor 402 receives route information 438 communicating that the remaining trip distance is 20 miles. The power boost request processor 402 receives information related to the available battery power 432 communicating that the available battery power comprises a remaining range of 30 miles. Look ahead information 434 further communicates to the power boost request processor 402 that the traffic speed 2 miles from the vehicle’s current position is 0 miles per hour, the road grade 2 miles from the current position is -2%, and the speed limit 2 miles from the current position is 55 miles per hour. The power boost request processor 402 therefore does not enable a power boost event in order to conserve a state of charge of the battery power and indicates the determination to the driver using the digital output 404 and/or the datalink status message 406.

Now referring to FIG. 3, another example 500 of a power boost event request is shown. In the illustrated example, the relevant vehicle is a BEV with a multi-speed transmission, wherein no look ahead information is available. Four categories of considerations are considered, including chance of damage or wear to components as shown by label 550, chance of reduced system performance as shown by label 552, efficiency for current conditions or need for power boost as shown by label 554, and chance of a vehicle safety event as shown by label 556.

In determining the chance of damage or wear to components 550, the processor 502 considers whether the electric machine or battery of the BEV will overheat, whether the battery configuration of the vehicle will cross a minimum SOC threshold, and whether the torque capacity of the driveline or transmission can withstand the power boost event, should the power boost feature be enabled. As discussed above, the processor 502 may receive information related to the temperature of the electric machine or battery of the BEV from the cooling system 516 of the vehicle. A thermostat serves to monitor the temperature of the electric machine and/or battery of the vehicle. If the vehicle is providing a higher amount of power, the amount of heat released in a shorter amount of time increases. Such considerations may be communicated to the processor 502, as the cooling system operation affects efficient and productive operation of the vehicle. For example, a predetermined thermal threshold may dictate the availability of a power boost event. If the coolant temperature is below the threshold, the processor 502 may enable the power boost feature. If the coolant temperature is above or equal to the threshold, the processor 502 may inhibit or otherwise limit the power boost feature to ensure that the cooling system 516 stays below the predetermined thermal threshold.

As discussed above, the processor 502 is further configured to receive and consider information related to the state of charge of a battery configuration of the vehicle. For example, the processor 502 receives information related to the available battery power 532. If the available battery power 532 is below a minimum state of charge threshold, the processor 502 inhibits or otherwise limits the power boost feature. The processor 502 may further calculate the amount of battery power that would be used with enablement of the power boost feature. The processor 502 may only enable the power boost feature if enablement would ensure that the state of charge of the battery configuration would remain above the minimum state of charge threshold. The processor 502 may otherwise limit the power boost feature to ensure that the state of charge of the battery configuration remains above the minimum state of charge threshold.

The processor 502 may also consider the battery health index 536 of the vehicle when considering the chance of damage or wear to components. For example, if the battery health index 536 is below a certain threshold, the processor 502 may inhibit the power boost feature. If the battery health index 536 is below a calibratable threshold, for example, the processor 502 may inhibit the power boost feature. As the battery health index 536 decreases with use or age, the processor 502 may limit or inhibit the power boost feature to prevent further deterioration of the battery state of health. However, if no diagnostic faults are active in an inverter or within the electric system of the vehicle, the power boost feature may be enabled in consideration with the other information systems discussed herein.

The processor 502 may also receive information related to the torque capacity of the driveline or transmission 546. For example, if the power boost feature increases torque above the maximum capacity threshold of the driveline or transmission, the processor 502 will inhibit or limit the enablement of the power boost feature. In other words, if the driveline or transmission is only capable of supporting a power boost event for a percentage of the vehicle operation, the power boost feature is limited by the processor 502 to meet the maximum capacity threshold of the driveline or transmission.

Still referring to FIG. 3, in determining the chance of reduced system performance 552, the processor 502 again considers whether the electric machine or battery of the BEV will overheat and whether the state of charge of the battery configuration of the vehicle will reach the minimum state of charge threshold. The cooling system 516 and the available battery power 532 discussed above also applies in the processor 502 determination of the chance of reduced system performance 552. Additionally, as the cooling system 516 approaches the threshold, the electric machine or battery may de-rate to prevent damage to the component. Similarly, if the battery configuration causes the available battery power 532 to approach the minimum state of charge threshold, the battery power may de-rate. To prevent de-rating of the battery power, the electric machine, and/or battery, the processor 502 may limit or inhibit the power boost feature.

In determining the efficiency for current conditions or need for a power boost event 554, the processor 502 may consider the vehicle mass 510, the vehicle speed 522, position of the accelerator pedal 524, and information communicated by the road-grade sensor 526, among other information systems described above. For example, the measured values of vehicle mass 510 and vehicle speed 522 may be used for physical movement calculations related to force, work, acceleration, and power. These calculations can be used to determine a final velocity after an acceleration event and distance traveled during an acceleration event. Such calculations can be used by the processor 502 to foresee the effect utilization of the power boost feature may have on the vehicle with or without consideration of other vehicle information discussed herein, including determining if a final vehicle speed is in compliance with a predetermined maximum speed threshold, such as a speed limit imposed by regulation or other desired maximum speed of the vehicle.

Still referring to FIG. 3, the processor 502 may further consider information received from the road-grade sensor 526 when determining the efficiency for current conditions or need for a power boost event 554. As discussed above, the road-grade sensor 526 provides information relating to the slope of the road on which the vehicle is traveling. During an uphill or downhill event, information related to the grade or slope of the road is an important component in acceleration calculations and other calculations requiring an accurate acceleration calculation due to the effects of gravity. This information is important in the calculations discussed above in connection to the vehicle speed 522 and the vehicle mass 510 to foresee the effect utilization of the power boost feature may have on the vehicle.

As discussed above, the position of the accelerator pedal 524 of the vehicle provides information that may facilitate a determination of whether the power boost feature should be enabled. For example, in vehicles having an accelerator pedal kick down switch 512, the position of the accelerator pedal 524 may determine whether the pedal kick down switch 512 is enabled or will potentially be enabled. The position of the accelerator pedal 524 may also provide information related to the potential acceleration rate of the vehicle, allowing the processor 502 to determine if the vehicle is accelerating at the proper rate according to the accelerator pedal position 524. For example, if the vehicle’s acceleration rate is low in comparison with the position of the accelerator pedal 524, the processor 502 may determine that the vehicle requires more power. If the vehicle’s acceleration rate is high in comparison with the position of the accelerator pedal 524, the processor 502 may determine that the vehicle does not require more power.

In determining the chance of a vehicle safety event 556, the processor 502 may consider weather conditions 542 and advanced driver-assistance systems 544. For example, if the weather conditions 542 are such that the roads may be slippery due to ice, snow, or rain, the power boost feature may be limited or prohibited to avoid placing the vehicle in an unsafe situation. Similarly, if an advanced driver-assistance system 544 such as, but not limited to, at least one of a backup camera, blind spot monitor, collision avoidance system, forward collision warning, lane departure warning system, or another advanced driver-assistance system 544 as discussed further herein indicates that a vehicle is in traffic or a vehicle is otherwise too closely located to the current vehicle, the power boost feature may be limited or prohibited to avoid placing the vehicle in an unsafe situation.

Now referring to FIG. 4, an example 600 of a power boost event request is shown. In the illustrated example, the relevant vehicle is a BEV with a multi-speed transmission and a look ahead feature 634. Four categories of considerations are considered, including chance of damage or wear to components as shown by label 650, chance of reduced system performance as shown by label 652, efficiency for current conditions or need for power boost as shown by label 654, and chance of a vehicle safety event as shown by label 656.

In considering the chance of damage or wear to components 650, the processor 602 considers whether the electric machine or battery of the BEV will overheat, whether the battery configuration of the vehicle will cross a minimum state of charge threshold, and whether the torque capacity of the driveline or transmission can withstand the power boost as discussed above with the vehicle of FIG. 3. Additionally, the look ahead information 634 may be utilized to conduct an appropriate simulation model of the vehicle to determine whether the electric machine or battery of the BEV will to overheat, whether the battery configuration of the vehicle will cross a minimum state of charge threshold, and whether the torque capacity of the driveline or transmission can withstand the power boost at different utilization percentages of the power boost feature.

In other words, the look ahead information 634 may conduct a simulation to determine these considerations at 100% of power boost feature output, at 90% of power boost feature output, at 80% of power boost feature output, at 70% of power boost feature output, at 60% of power boost feature output, at 50% of power boost feature output, at 40% of power boost feature output, at 30% of power boost feature output, at 20% of power boost feature output, and at 10% of power boost feature output. Any range of the power boost feature output between 0% and 100% may be considered. The look ahead information 634 may communicate these findings to the processor 602 so that the processor 602 can select the proper level of power boost feature utilization to ensure that the electric machine or battery of the BEV stays below the maximum thermal threshold, that the battery configuration of the vehicle will not cross the minimum state of charge threshold, and that the torque capacity of the driveline or transmission is not exceeded.

In considering the chance of reduced system performance 652, the processor 602 again considers whether the electric machine or battery of the BEV will overheat and whether the state of charge of the battery configuration of the vehicle will reach the minimum state of charge threshold as discussed above with the vehicle of FIG. 3. Additionally, the look ahead information 634 may be utilized to conduct an appropriate simulation model of the vehicle to determine the de-rate strategy of the electric machine or battery as the maximum thermal threshold is approached and the de-rate strategy of the battery power as the minimum state of charge threshold is approached.

In other words, the look ahead information 634 may conduct a simulation to determine these considerations at 100% of power boost feature output, at 90% power boost feature output, at 80% of power boost feature output, at 70% of power boost feature output, at 60% of power boost feature output, at 50% of power boost feature output, at 40% of power boost feature output, at 30% of power boost feature output, at 20% of power boost feature output, and at 10% of power boost feature output. Any range of the power boost feature output between 0% and 100% may be considered. The look ahead information 634 may communicate these findings to the processor 602 so that the processor 602 can select the proper level of power boost feature utilization to avoid thermal de-rate of the electric machine or battery and avoid state of charge de-rate of the battery configuration.

Still referring to FIG. 4, in determining the efficiency for current conditions or need for a power boost event 654, the processor 602 may consider the vehicle mass 610, the vehicle speed 622, position of the accelerator pedal 624, and information communicated by the road-grade sensor 626, among other information systems described above in connection with the vehicle of FIG. 3. Additionally, the look ahead information 634 may introduce further information to the processor 602 for the determination of efficient use of the power boost feature or need for the power boost feature.

Look ahead information 634 may provide information to the processor 602 to identify speed limits, traffic conditions, changes in traffic speed, upcoming hill events, and weather conditions 642. Such information may be used by the processor 602 to determine if a power boost event should or should not be enabled. If the look ahead information 634 identifies an upcoming event that may affect the desired speed of the vehicle, such information can be used by the processor 502 to foresee the effect utilization of the power boost feature may have on the vehicle with or without consideration of other vehicle information discussed herein, including determining if a final vehicle speed is in compliance with a predetermined maximum speed threshold, such as a speed limit imposed by regulation or other desired maximum speed of the vehicle.

For example, if a user requests a power boost event, the look ahead information 634 may identify an upcoming speed limit change, wherein the enablement of the power boost feature may place the vehicle at higher end speed than allowed by the speed limit corresponding to the end position of the vehicle. In such an event, the processor 602 may inhibit or otherwise limit the power boost feature. Similar predictions may occur using any other upcoming event identifiable by the look ahead information 634, including traffic conditions, changes in traffic speed, upcoming hill events, and weather conditions 642, among other information.

The look ahead information 634 may further conduct a simulation according to the identified upcoming events at 100% of power boost feature output, at 90% power boost feature output, at 80% of power boost feature output, at 70% of power boost feature output, at 60% of power boost feature output, at 50% of power boost feature output, at 40% of power boost feature output, at 30% of power boost feature output, at 20% of power boost feature output, and at 10% of power boost feature output. Any range of the power boost feature output between 0% and 100% may be considered. The look ahead information 634 may communicate these findings to the processor 602 so that the processor 602 can select the proper level of power boost feature utilization to avoid inefficient or unnecessary use of the power boost feature.

In determining the chance of a vehicle safety event 656, the processor 602 may consider weather conditions 642 and advanced driver-assistance systems 644 as discussed above in connection with the vehicle of FIG. 3. Look ahead information 634 may provide information to the processor 602 to identify traffic events and weather conditions 642. Such information may be used by the processor 602 to determine if a power boost event should or should not be enabled. If the look ahead information 634 identifies an upcoming event that may place the vehicle in an unsafe situation, such information can be used by the processor 602 to foresee the effect utilization of the power boost feature may have on the vehicle with or without consideration of other vehicle information discussed herein.

The look ahead information 634 may further conduct a simulation according to the identified upcoming events at 100% of power boost feature output, at 90% power boost feature output, at 80% of power boost feature output, at 70% of power boost feature output, at 60% of power boost feature output, at 50% of power boost feature output, at 40% of power boost feature output, at 30% of power boost feature output, at 20% of power boost feature output, and at 10% of power boost feature output. Any range of the power boost feature output between 0% and 100% may be considered. The look ahead information 634 may communicate these findings to the processor 602 so that the processor 602 can select the proper level of power boost feature utilization to avoid placing the vehicle in an unsafe situation.

Now referring to FIG. 5, an example 700 of a power boost event request is shown. In the illustrated example, the relevant vehicle is a REEV, or a BEV with a range extender, wherein the range extender comprises an internal combustion engine fueled by diesel, gasoline, or natural gas and a generator coupled to the internal combustion engine. Five categories of considerations are considered, including chance of damage or wear to components as shown by label 750, chance of reduced system performance as shown by label 752, efficiency for current conditions or need for power boost as shown by label 754, chance of a vehicle safety event as shown by label 756, and chance of increased emissions as shown by label 758. In this vehicle embodiment, the electrical energy required for the power boost feature may be sourced from either the battery of the range extender of the vehicle.

In considering the chance of damage or wear to components 750, the processor 702 considers whether the electric machine or battery of the vehicle will overheat, whether the battery configuration of the vehicle will cross a minimum state of charge threshold, and whether the torque capacity of the driveline or transmission can withstand the power boost as discussed above with the vehicles of FIGS. 3 and 4 respectively. Because the vehicle of FIG. 5 includes a range extender, the processor 702 may consider that a portion of the electrical energy needed for the power boost event can be sourced from the range extender. Therefore, while a power boost event entirely sourced from the battery may cause the battery to overheat, the processor 702 may source a portion of the needed energy from the battery and the remaining portion of the needed energy from the range extender to allow the power boost event without causing the battery to overheat.

Similarly, while a power boost event entirely sourced from the battery may cause the state of charge of the battery configuration to reach the minimum state of charge threshold, the processor 702 may source a portion of the needed energy from the battery and the remaining portion of the needed energy from the range extender to enable the power boost event without crossing the minimum state of charge threshold. In the event where sourcing a portion of the needed energy from each of the range extender and the battery will cause the battery to overheat, the processor 702 may limit or inhibit the power boost feature. Similarly, in the event where sourcing a portion of the needed energy from each of the range extender and the battery will cause the battery configuration of the vehicle to reach the minimum state of charge threshold, the processor 702 may limit or inhibit the power boost feature. In the event the vehicle has a look ahead information feature 734, such feature may operate as described above with regard to FIG. 4.

Still referring to FIG. 5, in considering the chance of reduced system performance 752, the processor 702 again considers whether the electric machine or battery of the vehicle will overheat and whether the state of charge of the battery configuration of the vehicle will reach the minimum state of charge threshold as discussed above with the vehicles of FIGS. 3 and 4 respectively. Again, because the vehicle of FIG. 5 includes a range extender, the processor 702 may consider that a portion of the electrical energy needed for the power boost event can be sourced from the range extender. Therefore, while a power boost event entirely sourced from the battery may cause the battery to de-rate to prevent damage to the battery or electric machine, the processor 702 may source a portion of the needed energy from the battery and the remaining portion of the needed energy from the range extender to allow the power boost event without causing the battery to de-rate.

Similarly, while a power boost event entirely sourced from the battery may cause the battery power of the vehicle to de-rate, the processor 702 may source a portion of the needed energy from the battery and the remaining portion of the needed energy from the range extender to enable the power boost event without causing the battery power of the vehicle to de-rate. In the event where sourcing a portion of the needed electric energy from each of the range extender and the battery will cause the battery to de-rate, the processor 702 may limit or inhibit the power boost feature. Similarly, in the event where sourcing a portion of the needed energy from each of the battery and the range extender will cause the battery power of the vehicle to de-rate, the processor 702 may limit or inhibit the power boost feature. In the event the vehicle has a look ahead information feature 734, such feature may operate as described above with regard to FIG. 4.

In determining the efficiency for current conditions or the need for a power boost event 754, the processor 702 may consider the vehicle mass 710, the vehicle speed 722, position of the accelerator pedal 724, and information communicated by the road-grade sensor 726, among other information systems described above in connection with the vehicles of FIGS. 3 and 4 respectively. In the event the vehicle has a look ahead information feature 734, such feature may operate as described above with regard to FIG. 4.

Still referring to FIG. 5, in determining the chance of a vehicle safety event 756, the processor 702 may consider weather conditions 742 and advanced driver-assistance systems 744 as discussed above in connection with the vehicles of FIGS. 3 and 4 respectively. In the event the vehicle has a look ahead information feature, such feature may operate as described above with regard to FIG. 4.

In considering the chance of increased emissions 758, the processor 702 determines whether the power boost feature requires energy sourced from the range extender as discussed above. If the range extender is required for execution of the power boost event, the processor 702 considers a health index of an aftertreatment system 760 of the vehicle. If execution of the power boost feature requires energy sourced from the range extender and the aftertreatment system health index 760 is below a certain threshold, that is, if the aftertreatment system health index 760 results in low emissions conversion efficiency, the processor 702 may inhibit the power boost feature or otherwise limit the power boost feature so that the range extender is not needed for execution.

Existence of zero emission zones or low emission zones 740 may also be considered by the processor 702 in determining whether to enable a power boost feature for a vehicle having a range extender. If the vehicle is in a zero emission zone or a low emission zone 740 or a zero emission zone or low emission zone 740 is otherwise identified as upcoming on the vehicle route, the processor 702 may consider the existence of the zero emission zone or low emission zone 740 in determining whether to enable the power boost feature. For example, if the range extender is required for execution of the power boost event, the processor 702 determines if the vehicle is in a zero emission zone or a low emission zone 740. If the vehicle is in a zero emission zone 740, the processor 702 inhibits the power boost feature or otherwise limits the power boost feature so that the range extender is not used.

If the vehicle is in a low emission zone 740, the processor 702 considers the aftertreatment system health index 760. If the range extender may be used while maintaining the vehicle under the low emission zone threshold, the processor 702 enables the power boost feature. If the range extender may be used only to a certain extent while maintaining the vehicle under the low emission zone threshold, the processor 702 enables the power boost feature while sourcing only an amount of energy from the range extender that allows the vehicle to remain under the low emission zone threshold. If the range extender cannot be used while maintaining the vehicle under the low emission zone threshold, the processor 702 inhibits the power boost feature or otherwise limits the power boost feature so that the range extender is not used.

Still referring to FIG. 5, the vehicle may optionally include a look ahead information feature 734 to provide information to the processor 702 related to upcoming zero emission or low emission zones 740. Such information may be used by the processor 702 to determine if a power boost event should or should not be enabled. The look ahead information 734 may further conduct a simulation according to the identified upcoming zero emission zone or low emission zone 740 at 100% of power boost feature output, at 90% power boost feature output, at 80% of power boost feature output, at 70% of power boost feature output, at 60% of power boost feature output, at 50% of power boost feature output, at 40% of power boost feature output, at 30% of power boost feature output, at 20% of power boost feature output, and at 10% of power boost feature output. Any range of the power boost feature output between 0% and 100% may be considered. The look ahead information 734 may communicate these findings to the processor 702 so that the processor 702 can select the proper level of power boost feature utilization to avoid improper increased emissions.

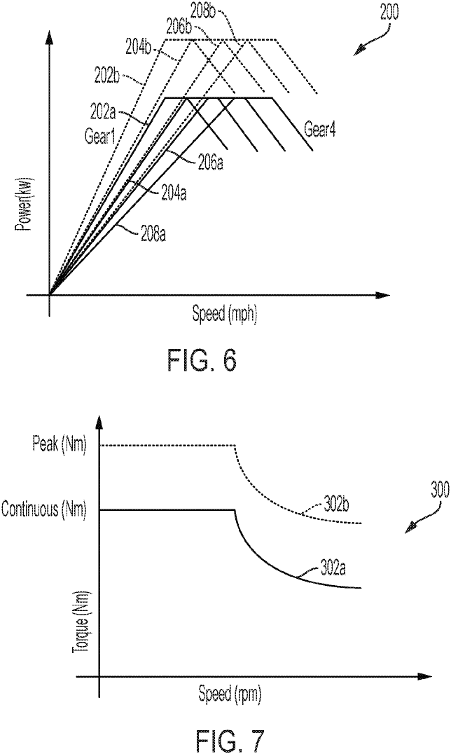

Now referring to FIG. 6, a graphical representation of the power boost event for a BEV is shown by graph 200. The power of the vehicle is portrayed along the y-axis in kilowatts, and the speed of the vehicle is portrayed along the x-axis in miles per hour. Line 202a represents the power of the vehicle at a given speed of the vehicle in a first gear without the use of a power boost event. Line 202b represents the power of the vehicle at a given speed of the vehicle in a first gear with the use of a power boost event. Line 204a represents the power of the vehicle at a given speed of the vehicle in a second gear without the use of a power boost event. Line 204b represents the power of the vehicle at a given speed of the vehicle in a second gear with the use of a power boost event.

Still referring to FIG. 6, line 206a represents the power of the vehicle at a given speed of the vehicle in a third gear without the use of a power boost event. Line 206b represents the power of the vehicle at a given speed of the vehicle in a third gear with the use of a power boost event. Line 208a represents the power of the vehicle at a given speed of the vehicle in a fourth gear without the use of a power boost event. Line 208b represents the power of the vehicle at a given speed of the vehicle in a fourth gear with the use of a power boost event. As shown by graph 200, the power of the vehicle is substantially higher at any given speed and any given gear of the vehicle during utilization of the power boost feature.

Now referring to FIG. 7, a graphical representation of the power boost event for a BEV is shown by graph 300. The torque of the electric machine is portrayed along the y-axis in Newton meters, and the speed of the electric machine is portrayed along the x-axis in revolutions per minute. Line 302a represents the continuous torque of the electric machine without the use of a power boost event. Line 302b represents the peak torque of the electric machine with the use of a power boost event. As shown by graph 300, the torque of the electric machine, and hence, the vehicle, is substantially higher at any given speed during utilization of the power boost feature.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A power boost system comprising:
a processor configured to determine the level of available power boost, wherein the level of available power boost is determined by at least one of:
a chance of damage or wear to components;
a chance of reduced system performance;
efficiency for current conditions or need for a power boost event; and
a chance of a vehicle safety event; and
wherein the processor is further configured to apply the determined power boost level to a powertrain of a vehicle.

2. The power boost system of claim 1, further comprising at least one information system communicatively coupled to the processor, the information system including at least one of a position of an accelerator pedal, a state of an accelerator pedal kick down switch, an enablement switch on a dash of the vehicle, and a touch-screen display of the vehicle.

3. The power boost system of claim 1, further comprising a user interface comprising a digital output, a datalink status message, or a combination of the datalink status message and the digital output to communicate and display information by the processor, including the level of available power boost.

4. The power boost system of claim 1, further comprising an event log communicatively coupled to the processor.

5. A method of using a power boost system, the method comprising:
requesting a power boost event;
determining the level of available power boost via the processor, wherein the level of available power boost is determined by at least one of:
a chance of damage or wear to components;
a chance of reduced system performance;
efficiency for current conditions or need for the power boost event; and
a chance of a vehicle safety event; and
applying the determined power boost level to a powertrain of a vehicle.

6. The method of claim 5, further comprising providing information to the processor by an information system communicatively coupled to the processor, the information system comprising at least one of a position of an accelerator pedal, a state of an accelerator pedal kick down switch, an enablement switch on a dash of the vehicle, and a touch-screen display of the vehicle.

7. The method of claim 5, wherein the power boost system includes a user interface comprising a digital output, a datalink status message, or a combination of the digital output and the datalink status message, to communicate and display information by the processor, including level of available power boost.

8. The method of claim 5, wherein the power boost system includes an event log communicatively coupled to the processor.

9. The method of claim 5, wherein the level of available boost has a range between 0 and 100% of a reference value.

10. The method of claim 5, wherein the level of available boost has a value of either 0 or 100% of a reference value.

11. The method of claim 5, further comprising providing information to the processor by an information system communicatively coupled to the processor, the information system comprising at least one of the following when considering the chance of damage or wear to components:
a battery health index;
a battery temperature;
an electric machine temperature;
a power electronics temperature;
a battery state of charge; and
a torque capacity of a driveline or a transmission.

12. The method of claim 11, wherein the processor limits the level of the power boost event when at least one of:
the battery health index is below a calibratable threshold;
the powertrain health index is below a calibratable threshold;
a battery temperature is above or equal to a first predetermined battery thermal threshold;
the battery temperature is below or equal to a second predetermined battery thermal threshold;
an electric machine temperature is above or equal to a first predetermined electric machine thermal threshold;
the electric machine temperature is below or equal to a second predetermined electric machine thermal threshold;
a power electronics temperature is above or equal to a first predetermined power electronics thermal threshold;
the power electronics temperature is below or equal to a second predetermined power electronics thermal threshold;
a state of charge of a battery is equal to or below a predetermined minimum state of charge threshold;
a predicted battery health index is below a first calibratable threshold;
a predicted powertrain health index is below a second calibratable threshold;
a predicted battery temperature is above or equal to the first predetermined battery thermal threshold;
the predicted battery temperature is below or equal to the second predetermined battery thermal threshold;
a predicted electric machine temperature is above or equal to the first predetermined electric machine thermal threshold;
the predicted electric machine temperature is below or equal to the second predetermined electric machine thermal threshold;
a predicted power electronics temperature is above or equal to the first predetermined power electronics thermal threshold;
the predicted power electronics temperature is below or equal to the second predetermined power electronics thermal threshold;
a predicted state of charge of the battery is equal to or below the predetermined minimum state of charge threshold;
a torque capacity of a driveline or a transmission is predicted to be exceeded; and
any combination of the above events.

13. The method of claim 5, further comprising providing information to the processor by an information system communicatively coupled to the processor, the information system comprising at least one of the following when considering the chance of reduced system performance:
the battery state of charge;
available battery power; and
available electric machine power.

14. The method of claim 13, wherein the processor limits the level of the power boost event when at least one of:
the available electric machine power is below or equal to a predetermined electric machine power threshold;
the available battery power is below or equal to a predetermined battery power threshold;
a predicted available electric machine power is below or equal to the predetermined electric machine power threshold;
a predicted available battery power is below or equal to the predetermined battery power threshold; and
any combination of the above events.

15. The method of claim 5, further comprising providing information to the processor by an information system communicatively coupled to the processor, the information system comprising at least one of the following when considering efficiency for current conditions or need for the power boost event:
a look ahead information system;
a mass of a battery electric vehicle;
a speed of a battery electric vehicle;
a position of an accelerator pedal;
a road-grade sensor; and
a state of an accelerator pedal kick down switch.

16. The method of claim 15, wherein the processor limits the level of the power boost event when at least one of:
the speed of the battery electric vehicle is not in compliance with a predetermined maximum speed threshold;
an acceleration rate of the vehicle is high in comparison with the position of the accelerator pedal;
a predicted speed of the battery electric vehicle is not in compliance with the predetermined maximum speed threshold;
a predicted acceleration rate of the battery electric vehicle is high in comparison with the position of the accelerator pedal;
the processor otherwise determines enablement of the power boost event is inefficient; or
any combination of the above events.

17. The method of claim 5, further comprising providing information to the processor by an information system communicatively coupled to the processor, the information system comprising at least one of the following when considering the chance of a vehicle safety event:
a look ahead information system;
an advanced driver-assistance system; and
a weather condition.

18. The method of claim 17, wherein the processor limits the level of the power boost event when at least one of:
the weather condition includes at least one of an ice event, a snow event, and a rain event, wherein the weather condition causes slippery road conditions;
the advanced driver-assistance system indicates that a current battery electric vehicle is in traffic or another vehicle is otherwise closely located to the current battery electric vehicle;
a predicted weather condition includes at least one of an ice event, a snow event, and a rain event, wherein the predicted weather condition is predicted to cause slippery road conditions;
traffic is predicted on a route of the current battery electric vehicle; or
any combination of the above events.

19. A method of using a power boost system, the method comprising:
requesting a power boost event;
determining the level of available power boost via the processor, wherein the level of available power boost is determined by at least one of:
a chance of damage or wear to components;
a chance of reduced system performance;
efficiency for current conditions or need for a power boost event;
a chance of a vehicle safety event; and
a chance for increased emissions; and
applying the determined power boost level to a powertrain system.

20. The method of claim 19, further comprising providing information to the processor by an information system communicatively coupled to the processor, the information system comprising at least one of the following when considering the chance of damage or wear to components:
a battery health index;
a powertrain health index;
a battery temperature;
an electric machine temperature;
a power electronics temperature;
a battery state of charge; and
a torque capacity of a driveline or a transmission.

21. The method of claim 20, wherein the processor limits the level of the power boost event when at least one of:
the battery health index is below a first calibratable threshold;
the powertrain health index is below a second calibratable threshold;
the battery temperature is above or equal to a first predetermined battery thermal threshold;
the battery temperature is below or equal to a second predetermined battery thermal threshold;
the electric machine temperature is above or equal to a first predetermined electric machine thermal threshold;
the electric machine temperature is below or equal to a second predetermined electric machine thermal threshold;
the power electronics temperature is above or equal to a first predetermined power electronics thermal threshold;
the power electronics temperature is below or equal to a second predetermined power electronics thermal threshold;
the battery state of charge is equal to or below a predetermined minimum state of charge threshold;
a predicted battery health index is below the first calibratable threshold;
a predicted powertrain health index is below the second calibratable threshold;
a predicted battery temperature is above or equal to the first predetermined battery thermal threshold;
the predicted battery temperature is below or equal to the second predetermined battery thermal threshold;
a predicted electric machine temperature is above or equal to the first predetermined electric machine thermal threshold;
the predicted electric machine temperature is below or equal to the second predetermined electric machine thermal threshold;
a predicted power electronics temperature is above or equal to the first predetermined power electronics thermal threshold;
the predicted power electronics temperature is below or equal to the second predetermined power electronics thermal threshold;
a predicted battery state of charge is equal to or below the predetermined minimum state of charge threshold;
the torque capacity of the driveline or the transmission is predicted to be exceeded; and
any combination of the above events.

22. The method of claim 19, further comprising providing information to the processor by an information system communicatively coupled to the processor, the information system comprising at least one of the following when considering the chance of reduced system performance:
the battery state of charge;
an available battery power; and
an available electric machine power.

23. The method of claim 22, wherein the processor limits the level of the power boost event when at least one of:
the available electric machine power is below or equal to a predetermined electric machine power threshold;
the available battery power is below or equal to a predetermined battery power threshold;
a predicted available electric machine power is below or equal to the predetermined electric machine power threshold;
a predicted available battery power is below or equal to the predetermined battery power threshold; and
any combination of the above events.

24. The method of claim 19, further comprising providing information to the processor by an information system communicatively coupled to the processor, the information system comprising at least one of the following when considering efficiency for current conditions or need for the power boost event:
a look ahead information system;
a mass of a battery electric vehicle;
a speed of the battery electric vehicle;
a position of an accelerator pedal;
a road-grade sensor; and
an accelerator pedal kick down switch.

25. The method of claim 24, wherein the processor limits the level of the power boost event when at least one of:
the speed of the battery electric vehicle is not in compliance with a predetermined maximum speed threshold;
an acceleration rate of the battery electric vehicle is high in comparison with the position of the accelerator pedal;
a predicted speed of the battery electric vehicle is not in compliance with the predetermined maximum speed threshold;
a predicted acceleration rate of the battery electric vehicle is high in comparison with the position of the accelerator pedal;
the processor otherwise determines enablement of the power boost feature is inefficient; or
any combination of the above events.

26. The method of claim 19, further comprising providing information to the processor by an information system communicatively coupled to the processor, the information system comprising at least one of the following when considering the chance of a vehicle safety event:
a look ahead information system;
an advanced driver-assistance system; and
a weather condition.

27. The method of claim 26, wherein the processor limits the level of the power boost event when at least one of:
the weather condition includes at least one of an ice event, a snow event, and a rain event, wherein the weather condition causes slippery road conditions;
the advanced driver-assistance system indicates that a current battery electric vehicle is in traffic or another vehicle is otherwise closely located to the current battery electric vehicle;
a predicted weather condition includes at least one of an ice event, a snow event, or a rain event, wherein the predicted weather condition is predicted to cause slippery road conditions;
traffic is predicted on a route of the battery electric vehicle; or
any combination of the above events.

28. The method of claim 19, wherein the processor sources a portion of needed electrical energy from a range extender of a range extended electric vehicle to allow for an increase in the available level of power boost considering at least one of:
the battery health index remains above a calibratable threshold;
the powertrain health index remains above a calibratable threshold;
the battery temperature remains below a predetermined battery thermal threshold;
the electric machine temperature remains below a predetermined electric machine thermal threshold;
power electronics temperature remains below a predetermined power electronics thermal threshold;
the battery state of charge remains above a predetermined minimum state of charge threshold;
a predicted battery health index remains above the calibratable threshold;
a predicted battery temperature remains below a predetermined battery thermal threshold;
a predicted electric machine temperature remains below a predetermined electric machine thermal threshold;
a predicted power electronics temperature remains below a predetermined power electronics thermal threshold;
a predicted battery state of charge remains above a predetermined minimum state of charge threshold; or
any combination of the above events.

29. The method of claim 29, wherein the processor sources a portion of needed electrical energy from the range extender of the range extended electric vehicle to ensure that:
an available battery power remains above or equal to a predetermined minimum battery power threshold;
a predicted available battery power remains above or equal to the predetermined minimum battery power threshold; or
any combination of the above events.

30. The method of claim 19, further comprising providing information to the processor by an information system communicatively coupled to the processor, the information system comprising at least one of the following when considering the chance for increased emissions:
an aftertreatment system status;
an existence of a zero emission zone or a low emission zone; and
a look ahead information system.

31. The method of claim 30, wherein the processor limits the level of the power boost event so that enablement of the power boost feature does not require the processor to source a portion of an amount of needed electrical energy from a range extender of a range extended electric vehicle when the aftertreatment system status indicates a low emissions conversion efficiency.

32. The method of claim 30, wherein the processor limits the level of the power boost event so that enablement of the power boost feature does not require the processor to source a portion of an amount of needed electrical energy from a range extender of a range extended electric vehicle when use of the range extender will cause the range extended electrical vehicle to output emissions equal to or above a predetermined emissions output threshold.

33. The method of claim 32, wherein the range extended electrical vehicle is in a zero emissions zone, a low emissions zone, is predicted to be in a zero emissions zone, or is predicted to be in a low emissions zone.
